(19) United States
(12) Patent Application Publication
(10) Pub. No.: US 2001/0035708 A1
(43) Pub. Date: Nov. 1, 2001

(54) Color cathode ray tube

(76) Inventors: Yoshiaki Takahashi, Chiba (JP); Masayoshi Furuyama, Togane (JP); Takeshi Mera, Mobara (JP); Ken Kagabu, Ichinomiya (JP)

Correspondence Address: Christopher E. Chalsen, Esq., Milbank, Tweed, Hadley & McCloy LLP, 1 Chase Manhattan Plaza, New York, NY, 10005-1413, US

(21) Appl. No.: 09/836,568

(22) Filed: Apr. 17, 2001

(30) Foreign Application Priority Data
May 1, 2000 (JP) 2000-132435

(51) Int. Cl. H01J 29/50

(52) U.S. Cl. 313/414; 313/421

(57) ABSTRACT

The present invention provides a color cathode ray tube which can make the focusing of a center electron beam and side electron beams uniform by reducing the non-uniformity of the spot shape of electron beams depending on a deflection quantity.

The second electrode G2 includes three electron beam apertures made of one center electron beam aperture and two side electron beam apertures which are arranged in an in-line array. Each one of three electron beam apertures is formed of a rectangular recessed portion which has long sides in an in-line direction and a circular aperture which penetrates a center portion of the rectangular recessed portion. The depth of the recessed portion arranged at the center electron beam aperture is set larger than the depth of the recessed portions arranged at side electron beam apertures.

### BACKGROUND OF THE INVENTION

1. Field of the Invention

The present invention relates to a color cathode ray tube, and more particularly to a color cathode ray tube which can realize an optimum focusing over the entire region of a screen by reducing the non-uniformity of the shape of beam spots depending on a deflection quantity.

2. Related Art

In general, a glass-made envelope of a color cathode ray tube is made of a vacuum envelope which is constituted of a panel portion on which a display part (phosphor screen or screen) is formed, a narrow-diameter neck portion, and a funnel portion which connects the panel and the neck. The phosphor screen has an inner surface on which tri-color phosphors are coated and a color selection electrode (shadow mask) is arranged in the vicinity of the phosphor screen.

Further, an electron gun which emits three electron beams is accommodated in the inside of the neck. Three electron beams emitted from the electron gun are made to pass through electron beam apertures formed on the shadow mask and thereafter impinge on respective red, green and blue phosphors to reproduce color images.

The electron gun is provided with a cathode, an electron beam generating portion which arranges a first electrode and a second electrode in sequence, and an electron lens forming portion which includes a focusing electron lens and an acceleration electron lens which respectively focus and accelerate the electron beams generated by the electron beam generating portion. These focusing electron lens and the acceleration electron lens (including a main lens) are formed of a plurality of electrodes such as a third electrode disposed close to the second electrode and a fourth electrode and the like which are arranged in sequence from the third electrode side to the phosphor screen side. Each one of these electrodes includes three electron beam apertures consisting of a center electron beam aperture and side electron beam apertures arranged in an in-line array.

FIG. 7A and FIG. 7B are schematic views explaining the constitution of a second electrode of an electron gun used in a conventional color cathode ray tube, wherein FIG. 7A is a plan view of the second electrode as seen from a third electrode side and FIG. 7B is a cross-sectional view taken along a line I-I of FIG. 7A.

Electron beam apertures formed in an in-line array in the second electrode G2 are made of circular through apertures d4, d5, d6. Surrounding these circular electron beam apertures d4, d5, d6, recessed portions h1, h2, h3 having long sides thereof in the in-line direction are formed at the third electrode side.

The through length tdc of the center through aperture d5 is made equal to the through length tds of the side through apertures d4, d6 and the depth the of the center rectangular recessed portion h1 is made equal to the depth ths of the side rectangular recessed portions h2, h3. T indicates a plate thickness of an electrode plate which constitutes the second electrode 02.

FIG. 8A is a schematic view for explaining the change of the cross-sectional shape of electron beams by a deflection magnetic field. A bundle of electron beams emitted from the electron gun is deflected by the deflection magnetic field in the midst of the way toward a phosphor screen formed on the inner surface of the panel. Here, the bundle of electron beams is subjected to a force Fx which exhibits a diversion action in the horizontal direction (in-line direction) due to the deflection magnetic field and is also subjected to a force Fy which exhibits a conversion action in the vertical direction. Accordingly, the bundle of electron beams is deformed in a flattened cross-sectional shape having a long axis thereof in the horizontal direction. The distortion of the electron beams deteriorates the resolution of reproduced images.

FIG. 8B is a schematic view for explaining an action of an electrostatic quardruple lens. The electrostatic quardruple lens is an electron lens for correcting the distortion of the electron beams derived from the deflection magnetic field. The electrostatic quardruple lens is formed between a G3-1 electrode and a G3-2 electrode which are made by dividing a third electrode G3. The electrostatic quardruple lens has a force Fx′ which exhibits a conversion action in the horizontal direction and a force Fy′ which exhibits a diversion action in the vertical direction.

Further, to correct the difference of lens magnification at the main lens between the horizontal direction and the vertical direction, the rectangular recessed portions h1, h2, h3 formed in the second electrode G2 have a function of laterally elongating the bundle of electron beams (quadruple lens action). The difference of lens magnification at the main lens between the horizontal direction and the vertical direction is generated when the electron beams which are subjected to the electrostatic quadruple electron lens action in the inside of the third electrode G is incident on the main lens. By forming the rectangular recessed portions in the second electrode G2, the difference of lens magnification at the main lens between the horizontal direction and the vertical direction can be corrected and hence, the optimum focusing of the electron beams is obtained over the entire region of the phosphor screen.

As a literature which discloses a color cathode ray tube having this type of electron gun, for example, Japanese Patent Laid-open No.40137/1987 can be named.

According to the above-mentioned prior art, the center electron beam which passes the center of the deflection magnetic field can obtain the optimum focusing over the entire region of the phosphor screen. On the other hand, the side electron beams have a problem that they differ in the shape of spot between the case in which the side electron beam is deflected toward the left side of the phosphor screen and the case in which the side electron beam is deflected toward the right side of the phosphor screen.

This problem is caused due to the fact that the side electron beam is incident on the deflection magnetic field with the center axis of the side electron beam offset from the center axis of the center electron beam by a distance S. The influence of the deflection magnetic field on the side electron beams largely differ between the case in which the side electron beam is deflected toward the left side of the phosphor screen and the case in which the side electron beam is deflected toward the right side of the phosphor screen.

FIG. 10A shows the state in which the side electron beam which is spaced apart from the tubular axis TC by the distance S is moved to the left and right-side directions by L by the deflection magnetic field. FIG. 10B shows a focusing action or a diversion action which the side electron beam receives when the side electron beams moves in the left and right directions by the distance L. Further, FIG. 10B shows the electron beam and the magnetic field when viewed from the screen side. FIG. 10C shows the spot shape of the electron beam on the phosphor screen in the state that the electron beam is deflected to the left by the distance L. FIG. 10D shows the spot shape of the electron beam on the phosphor screen in the state that the electron beam is deflected to the right by the distance L. In FIG. 10A, FIG. 10B, FIG. 10C and FIG. 10D, TC is the center of tube axis, B indicates the deflection magnetic field. Particularly, BL indicates the deflection magnetic field which acts on the side electron beam when the side electron beam is deflected to the left and BR indicates the deflection magnetic field which acts on the side electron beam when the side electron beam is deflected to the right.

As shown in FIG. 10B, when the side electron beam is deflected in the left and right directions of the phosphor screen with the same distance L, the electron beam passes the deflection magnetic field where the curving is gentle when the electron beam is deflected to the left side, while the electron beam passes the deflection magnetic field where the curving is large when the electron beam is deflected to the right side.

When the electron beam is deflected, irrespective of the deflection direction, the electron beam receives the diversion action in the horizontal direction and the focusing action in the vertical direction. The actions of the deflection magnetic field at the time of deflecting the electron beam to the left side and the right side are explained.

In FIG. 10B, the diversion action in the horizontal direction and the focusing action in the vertical direction and the magnetic field strength in the left-side deflection are respectively set to FLx, FLy and BL, while the diversion action in the horizontal direction and the focusing action in the vertical direction and the magnetic field strength in the right-side deflection are respectively set to FRx, FRy and BR.

When the electron beam is respectively deflected to the left side and the right side by the same distance (L), with respect to the magnetic strengths BL and BR of the deflection magnetic field at respective left and right sides, the relationship BL<BR is set between BL and BR, while with respect to the diversion action or the focusing action of the magnetic field to the electron beam at respective sides, the relationships FLx<FRx, FLy<FRy are set.

Accordingly, the electron beam exhibits the large distortion in the right-side deflection direction compared to the left-side deflection. The spot shape of the beam on the phosphor screen shows the large hallow HC in the up and down directions at the right-side deflection shown in FIG. 10D compared to the left-side deflection shown in FIG. 10C. A core CC of the electron beam spot becomes a laterally elongated shape and the side electron beams exhibit non-uniform spot shapes at the left and right of the phosphor screen. This constitutes one of tasks to be solved by the invention.

### SUMMARY OF THE INVENTION

Accordingly, it is an object of the present invention to make a focusing in a color cathode ray tube uniform over the entire region of a phosphor screen.

According to the present invention, a color cathode ray tube includes a vacuum envelope constituted of a panel, a neck and a funnel, a phosphor screen is formed on an inner surface of the panel, a color selection electrode is disposed in the vicinity of the phosphor screen, and an electron gun is accommodated in the inside of the neck. The electron gun includes an electron beam generating portion which consist of a cathode, a first grid electrode and a second grid electrode and focusing electrode which forms a main electron lens for focusing and accelerating the electron beams and an anode electrode. Each one of first electrode, the second electrode, the focusing electrode and the anode electrode has one center electron beam aperture and two side electron beam aperture (three electron beam apertures in total) and three electron beam apertures are arranged in an in-line array.

In the second electrode, each one of three electron beam apertures is formed of a rectangular recessed portion on a focusing electrode side which has long sides in the in-line direction and is recessed toward the thickness direction of the second electrode plate and a circular aperture which penetrates a center portion of the rectangular recessed portion.

The depth of the recessed portion of the center electron beam aperture is made greater than the depth of the recessed portion of the side electron beam aperture and the through length of the circular apertures of the side electron beam apertures is made larger than the through length of the circular aperture of the center electron beam aperture.

The present invention can provide a color cathode ray tube which can realize the optimum focusing on the entire screen by reducing the non-uniformity of the beam spot shape depending on a deflection quantity.

### BRIEF DESCRIPTION OF THE DRAWINGS

FIG. 1 is a schematic cross-sectional view for explaining the entire structure of a color cathode ray tube according to the present invention;

FIG. 2 is a schematic cross-sectional view of an electron gun accommodated in the inside of a neck of the color cathode ray tube of the present invention;

FIG. 3A shows a first example of the present invention and is a front view of a second electrode as viewed from a third electrode side, and

FIG. 3B is a cross-sectional view taken along a line II-II of FIG. 3A;

FIG. 4 is an explanatory view showing a cross-sectional structure of an electron beam emitted from a rectangular recessed portion after passing the second electrode;

FIG. 5 is a schematic view showing an electron lens, a locus of an electron beam and a spot shape of the electron beam;

FIG. 6A is a schematic view of a screen at a position as viewed from a front surface thereof,

FIG. 6B shows spot shapes of the center electron beam,

FIG. 6C shows spot shapes of the side electron beams of a conventional color cathode ray tube, and

FIG. 6D shows spot shapes of the side electron beams of a color cathode ray tube of the present invention;

FIG. 7A is a schematic view of a second electrode of an electron gun used in the conventional color cathode ray tube, and

FIG. 7B is a cross-sectional view taken along a line I-I of FIG. 7A;

FIG. 8A is a schematic view showing actions which a deflection magnetic field gives to an electron beam, and FIG. 8B is a schematic view showing actions which an electrostatic quadruple lens gives to an electron beam;

FIG. 9A is a schematic view showing the lens magnification in the vertical direction by the electrostatic quadruple lens arranged at a third electrode, and

FIG. 9B is a schematic view showing the lens magnification in the horizontal direction by the electrostatic quadruple lens arranged at the third electrode; and

FIG. 10A is an arrangement view of side electron beams in a deflection magnetic field as viewed from a screen side,

FIG. 10B is an explanatory view of the deflection magnetic field acting on the electron beam when the side electron beam is deflected to the right side or the left side of a phosphor screen,

FIG. 10C shows a spot shape of the electron beam when the right-side electron beam is deflected to the left side, and

FIG. 10D shows a spot shape of the electron beam when the right-side electron beam is deflected to the right side.

### DESCRIPTION OF THE PREFERRED EMBODIMENT

In the present invention, circular through apertures formed in a second electrode G2 control diameters of bundles of electron beams incident on a main lens.

When the bundle of electron beams is strongly stopped down using the second electrode G2, the diameter of the electron beam in the main lens and in a deflection magnetic field becomes small. Accordingly, a deformation quantity of electron beam in a peripheral portion of a phosphor screen derived from the deflection magnetic field can be reduced.

However, when the electron beam in the inside of the main lens is excessively stopped down, due to the repulsive action between electrons, the diameter of the electron beam spot on the phosphor screen is enlarged (the electron beam spot is swelled).

Further, when the stop of the electron beam is made weak, the diameter of the electron beam in the inside of the main lens and the diameter of electron beam in the inside of the deflection magnetic field become large. Accordingly, the repulsive force between the electrons becomes weak and hence, the diameter of the electron beam spot on the phosphor screen becomes small.

However, when the diameter of the electron beam is large, the electron beam strongly receives the influence of the deflection magnetic field and a deformation quantity of the electron beam in the peripheral portion of the phosphor screen becomes large. The diameter of the circular apertures formed in the second electrode G2 is determined by the balance between the diameter of the electron beam spot and the deflection of the electron beam at the time of deflection thereof.

An electrostatic quadruple lens for correcting the deflection magnetic field which is formed on a G3-1 electrode and a G3-2 electrode which constitute a third electrode G3 performs the correction of the lens magnification in the vertical and horizontal directions which are generated when the electron beam is incident on the main lens.

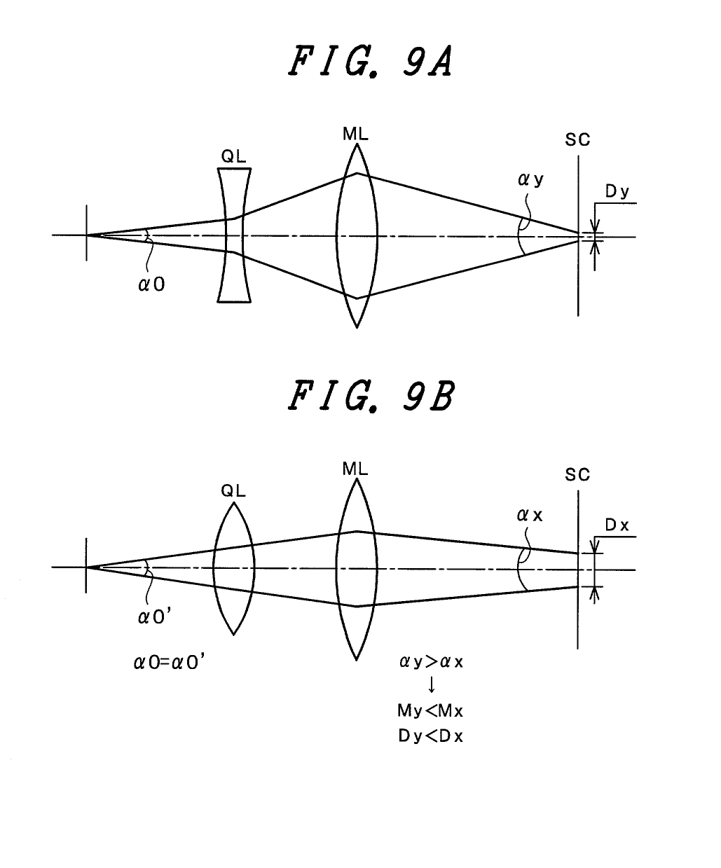

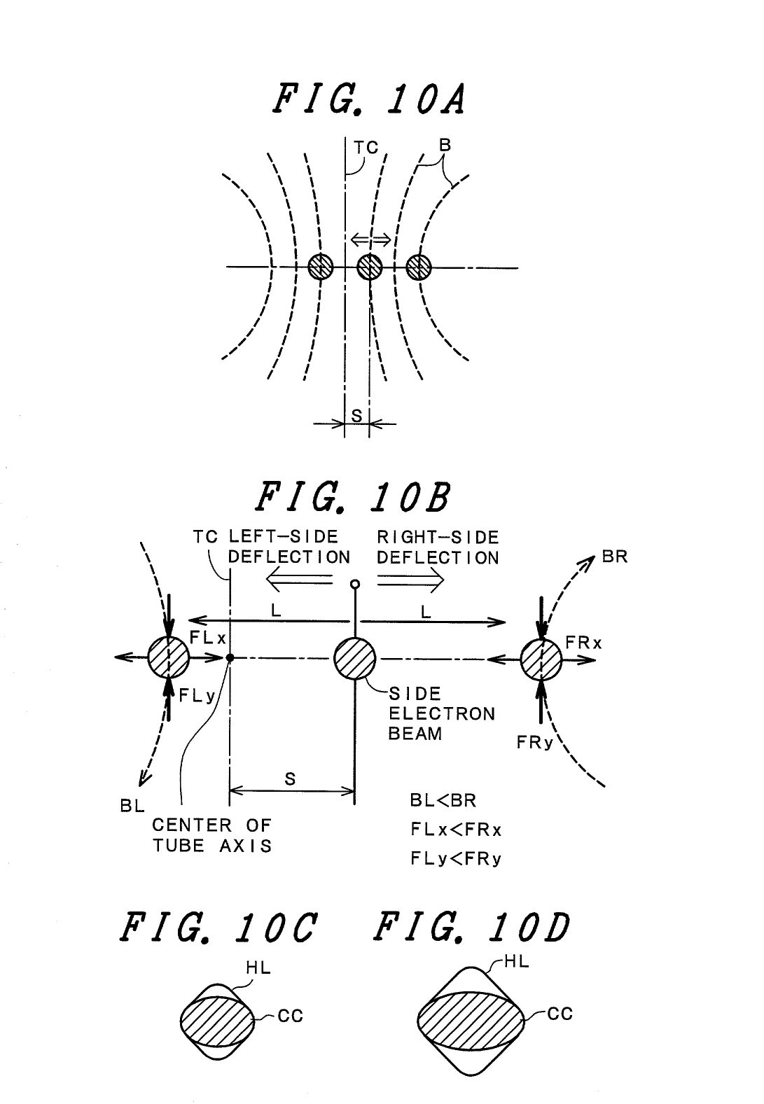

The cross section of the electron beam becomes longitudinally elongated due to the electrostatic quadruple lens formed on the G3-1 electrode and the G3-2 electrode. A bundle of electron beams having a longitudinally elongated cross section are incident on the main lens and are focused on the phosphor screen (peripheral portion). The magnification of the main lens at this point of time is explained in conjunction with FIG. 9.

FIG. 9 is a schematic view explaining the change of the lens magnification due to the electrostatic quadruple lens arranged in the third electrode. FIG. 9A shows the behavior of the electron beams at the vertical side and FIG. 9B shows the behavior of the electron beams at the horizontal side. In these drawings, αo, αo′ are respectively emission angles (αo=αo′) of the electron beam in the vertical direction and in the horizontal direction which is emitted from an electron beam generating portion and is incident on an electrostatic quadruple lens QL, αy, αx are respectively incident angles of the electron beam which is emitted from a main lens ML and is focused on a phosphor screen SC, and Dy,Dx are respectively spot diameters of the electron beam on the phosphor screen SC in the vertical direction and in the direction perpendicular to the vertical direction.

The relationship between the incident angles αx, αy of the electron beam in the horizontal direction and the vertical direction when the electron beam is focused on the phosphor screen SC is set as αx<αy and the lens magnification M (lens magnification in the horizontal direction: Mx, lens magnification in the vertical direction: My) of the main lens ML is inversely proportional to the incident angle on the phosphor screen SC and hence, the relationship Mx>My is set.

Accordingly, the spot diameter of the electron beam on the phosphor screen SC has the cross section thereof formed in a laterally elongated electron beam shape in view of the relationship between the diameter and the lens magnification and hence, the relationship between spot diameters Dx, Dy of the electron beam on the phosphor screen SC becomes Dy<Dx.

Since laterally elongated recessed portions h1, h2, h3 of the second electrode G2 have strong focusing actions in the vertical direction compared to the horizontal direction, the bundle of electron beams which is made to pass through each circular aperture of the second electrode G2 has a cross section formed in a laterally elongated electron beam shape.

This bundle of electron beams having the laterally elongated cross section receives the action from the electrostatic quadruple lens formed between the G3-1 electrode and the G3-2 electrode which constitute the third electrode G3 which tries to form the bundle of electron beams in a longitudinal shape. Due to this electrostatic quadruple lens, the bundle of electron beams has an incident angle thereof on the main lens corrected so that the incident angle on the phosphors screen SC can be made equal in the horizontal direction and the vertical direction. As a result, the lens magnifications in the horizontal direction and in the vertical direction can be made equal so that the beam spot on the phosphor screen can be formed in a circle.

Further, by making a color cathode ray tube have a following constitution, the non-uniformity of the beam spot shape derived from a deflection can be reduced so that an optimum focusing can be realized over the entire region of the screen.

That is, in the color cathode ray tube having a panel portion which has a phosphor screen formed on an inner surface thereof, a neck portion which houses an electron gun and a funnel portion which connects the panel portion and the neck portion, the electron gun includes an electron beam generating portion which arranges three cathodes in an in-line arrangement, a first electrode, a second electrode in sequence therein along a tube axis, and a focusing electrode and an anode electrode which form a main lens for focusing electron beams on a screen. Electron emission surfaces of these three cathodes are arranged on a same plane. The second electrode includes one center electron beam aperture and two side electron beam apertures and the electron beam apertures are constituted of through apertures having a circular shape (hereafter called “circular through apertures”) and recessed portions. The circular through apertures include one center circular through aperture and two side circular through apertures, while the recessed portions include one center recessed portion and two side recessed portions. The diameters in the vertical direction and the diameter in the horizontal direction of three recessed portions are larger than the diameters of three circular through apertures. The vertical diameters of three recessed portions are made all equal and the horizontal diameters of three recessed portions are made all equal.

The recessed portions are arranged at the focusing electrode side of the second electrode and formed in a rectangular shape having long sides thereof in the in-line direction.

The depth of the center recessed portion is made deeper than the depth of the side recessed portions and the through length of the circular side electron beam apertures is made larger than the through length of the circular center electron beam aperture.

The total of the through length of the circular aperture and the fall quantity of the rectangular recessed portion in the electron beam aperture of the second electrode is made equal between the center electron beam aperture and the side electron beam apertures. In this case, the circular apertures and the rectangular recessed portions are formed in a unitary plate member or the circular apertures are formed in one of two plate members and the rectangular recessed portions are formed in the other of two plate members and these plate members are laminated to each other.

The total of the through length of the circular aperture and the fall quantity of the rectangular recessed portion of the second electrode is made different between the center electron beam aperture and the side electron beam apertures. In this case, the circular aperture and the rectangular recessed portions are formed in a unitary plate member which differs in a plate thickness between the center portion and the side portions or the circular aperture is formed in one of two plate members which differ in a plate thickness and the rectangular recessed portions are formed in the other plate member and these plate members are laminated.

The difference of the through length of the circular aperture between the center electron beam aperture and the side electron beam apertures is set to from 0.02 mm to 0.05 mm.

Due to such a constitution, uniform focusing characteristics can be obtained over the entire region of the phosphor screen and hence, a color cathode ray tube having an improved screen quality can be obtained.

Although the above-mentioned operation and advantageous effects of the constitutions of the present invention are explained in detail hereinafter, the present invention is not limited to these and it is needless to say that various modifications can be conceivable without departing from the technical concept of the present invention.

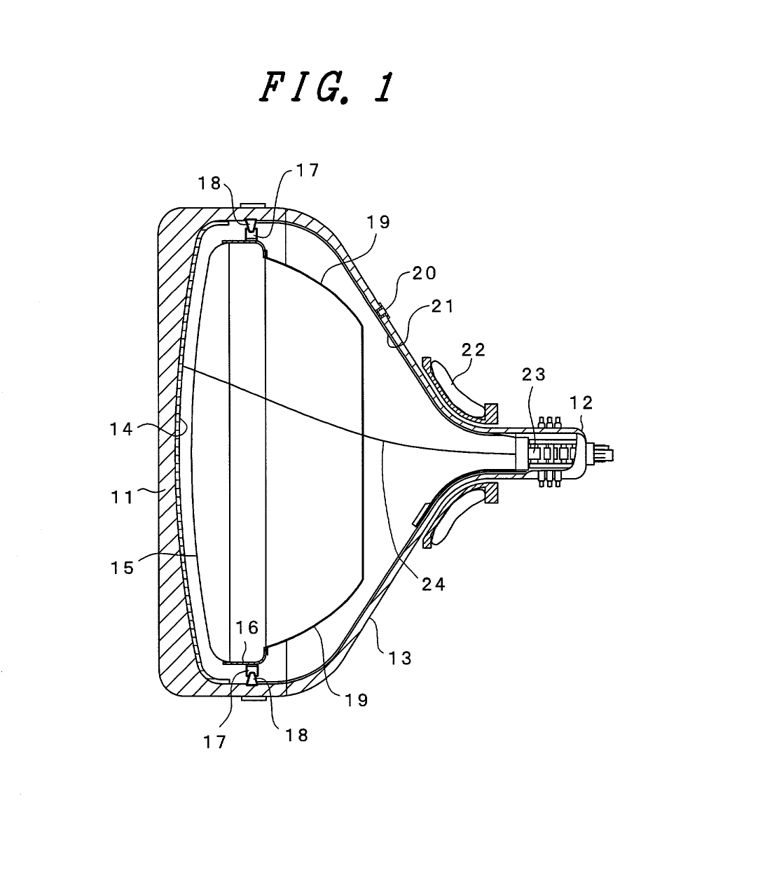

FIG. 1 is a schematic cross-sectional view for explaining an overall structure of a color cathode ray tube according to the present invention. Here, a flat panel-type color cathode ray tube is illustrated as an example. A panel 11 is jointed to a large-diameter periphery which constitutes one end of a funnel 13, while the other end of the funnel 13 which gradually decreases a diameter thereof is connected to the neck 12.

A phosphor screen 14 is formed on an inner surface of a panel and is constituted of a plurality of phosphors which have different coloring characteristics and a black matrix. A curved surface of an outer surface of the panel 11 has a large equivalent radius of curvature amounting to 8000 mm to 10000 mm, for example and appears approximately flat visually. In the panel 11, an equivalent radius of curvature of a curved surface of the inner surface thereof is made smaller than the equivalent radius of curvature of the outer surface to ensure the mechanical strength of a glass envelope.

A shadow mask 15 having a large number of beam apertures is arranged at a position close to the phosphor screen 14 formed on the inner surface of the panel 11. The shadow mask 15 is welded to a mask frame 16 and is supported by engaging the mask frame 16 with stud pins 18 formed on an inner surface of the side wall of the panel by a suspension mechanism 17.

A magnetic shield 19 for shielding a bundle of electron beams 24 from an outside magnetism such as an earth magnetism is mounted on the mask frame 16 at the electron gun side thereof.

An anode button 20 for introducing a high voltage (anode voltage) from the outside is mounted on a side wall of the funnel 13. An inner conductive film 21 which is electrically connected to the anode button 20 is coated on inner surfaces of the skirt portion of the panel 11 and the funnel 13 and on an inner surface of a front end of an electron gun accommodating portion of the neck 12. The high voltage applied through the anode button 20 is introduced to the phosphor screen and the anode of the electron gun through the inner conductive film 21.

Further, a deflection yoke 22 is exteriorly mounted on the neck side of the funnel 13. The deflection yoke 22 deflects a bundle of electron beams 24 in two directions, that is, the horizontal direction and the vertical direction. Accordingly, a two-dimensional image is reproduced on the phosphor screen 14.

Then, in the inside of the neck 12, an electron gun 23 which emits three electron beams in the direction toward the phosphor screen 14 is accommodated.

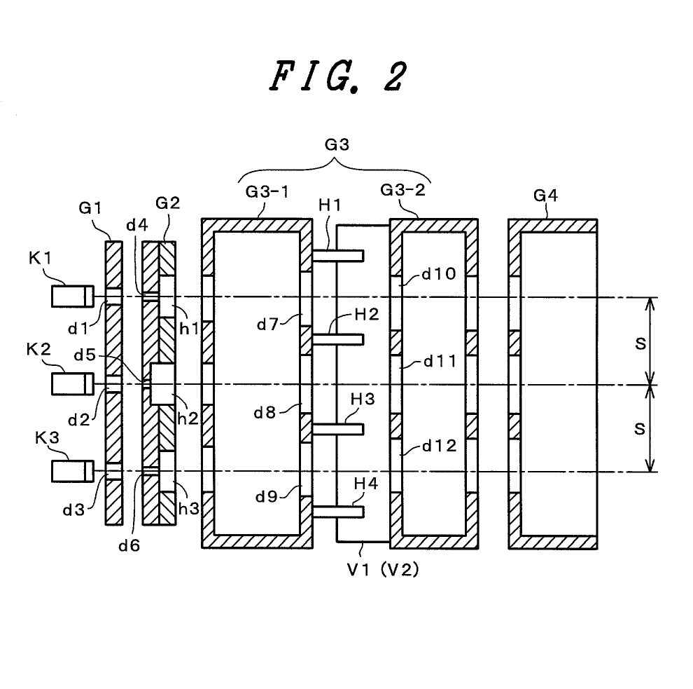

FIG. 2 is a schematic cross-sectional view for explaining a structural example of the electron gun accommodated in the inside of the neck. This electron gun is considered as one which is formed by integrating three electron guns as a unit and is provided with three cathodes K1, K2, K3 which are arranged in an inline array which is perpendicular to the tube axial direction of the color cathode ray tube. Further, the electron gun 3 includes a first grid electrode G1 which has three electron beam apertures d1, d1, d3, a second grid electrode G2 which similarly has three electron beam apertures d4, d5, d6, a third grid electrode G3 which is comprised of a G3-1 electrode and G3-2 electrode, and a fourth grid electrode G4. Here, d7, d8, d9 indicate electron beam apertures formed on the G3-2 electrode side of the G3-1 electrode and d10, d11, d12 indicate electron beam apertures formed on the G3-1 electrode side of the G3-2 electrode. The above-mentioned electron beam apertures are arranged in an in-line manner in the same direction as three cathodes.

Then, the cathodes K1, K2, K3, the first electrode Gi and the second electrode G2 constitute an electron beam generating portion (so-colled triod portion), while the third electrode G3, the fourth electrode G4 and other components which follow the fourth electrode G4 constitute a focusing and acceleration portion. A main lens is formed between the third electrode G3 and the fourth electrode G4. Further, although a shield cup is arranged at the phosphor screen side of the fourth electrode G4, such shield cup is omitted from the drawing.

The second electrode G2 is provided with rectangular recessed portions h1, h2, h3 at the third electrode G3 side. The rectangular recessed portions h1, h2, h3 respectively surround the through apertures d4, d5, d6 made of circular apertures, have long sides thereof in an in-line direction, and are recessed in the thickness direction of an electrode plate which constitutes the second electrode G2.

In the electron gun having such a constitution, vertical partition plates H1, H2, H3, H4 are formed in an erected manner on the G3-2 electrode side of the G3-1 electrode which constitutes a third electrode G3 such that the vertical partition plates H1, H2, H3, H4 sandwich the electron beam apertures d7, d8, d9 of the G3-1 electrode from the in-line array direction. Further, a pair of horizontal electrode plates V1, V2 (only one of them shown in the drawing) which sandwich the electron beam apertures d10, d11, d12 of the G3-2 electrode from the direction perpendicular to the in-line array direction are formed in an erected manner on the G3-2 electrode in the direction toward the G3-1 electrode. With these vertical partition plates H1, H2, H3, H4 and the horizontal electrode plates V1, V2, a so-called electrostatic quadruple lens is formed. In FIG. 2, initial passages of three electron beams indicated by a chained line define the distance S between them.

Voltages applied to respective electrodes at the time of operating the color cathode ray tube having such an electron gun are such that 0 V to −100 V is applied to the first grid electrode G1, 400 V to 1 kV is applied to the second grid electrode G2 and 5 kV to 7 kV which is an intermediate voltage compared to a high voltage (anode voltage) is applied to the G3-1 electrode.

A dynamic voltage which deflects the electron beams and has a voltage change ranging from the intermediate voltage to approximately 200 V to 600 V is applied to the G3-2 electrode and a voltage of 25 kV to 27 kV which is a high voltage compared to other electrodes is applied to the fourth grid electrode G4.

FIG. 3 is a schematic structural view of the second electrode which constitutes the electron gun for explaining the first embodiment of the color cathode ray tube of the present invention.

FIG. 3A is a plan view of the second electrode G2 as viewed from the third electrode G3 (G3-1 electrode) side and FIG. 3B is a cross-sectional view taken +along a line II-II of FIG. 3A.

The electron beam apertures arranged in the in-line array in the second electrode G2 are the through apertures d4, d5, d6 which constitute circular apertures. Further, the second electrode G2 includes rectangular recessed portions h1, h2, h3 which respectively surround the electron beam apertures d4, d5, d6 made of circular apertures at the third electrode G3 side (G3-1 electrode side). The rectangular recessed portions h1, h2, h3 have long sides in the in-line direction and are recessed in the electrode plate thickness direction of the second electrode G2.

The through length tdc of the center through aperture d5 and the through length tds of the side through apertures (circular apertures) d4, d6 are different from each other and the relationship tdc<tds is set between these through lengths. Further, the depth the of the center rectangular recessed portion h2 and the depth ths of the side rectangular recessed portions h1, h3 are also different from each other and the relationship thc>ths is set between these depths. Here, T indicates the thickness of an electrode plate which constitutes the second electrode G2.

The difference of through length of circular aperture (tds−tdc) between the center electron beam through aperture and the side electron beam aperture is set in a practical range of approximately 0.02 mm to 0.05 mm. Here, the plate thickness of the second electrode G2 is set to 0.3 mm.

In such a constitution, an electron lens formed by the side electron beam aperture has the larger strength of electric field which gives a focusing action than an electron lens which is formed by the center electron beam aperture. Accordingly, the diversion angle of a bundle of electron beams is suppressed so that it becomes possible to stop down the cross-sectional diameter of the electron beam in the main lens and in the deflection magnetic field.

As mentioned previously, when the bundle of the electron beams is excessively stopped down, the spot shape of the electron beam on the phosphor screen is swelled due to the repulsive action between the electrons. To prevent the occurrence of such a phenomenon, the depth ths of the laterally-elongated rectangular recessed portions h1, h3 which are formed at the sides of the second electrode G2 is made small so that the swelling of the spot shape of the electron beams can be suppressed.

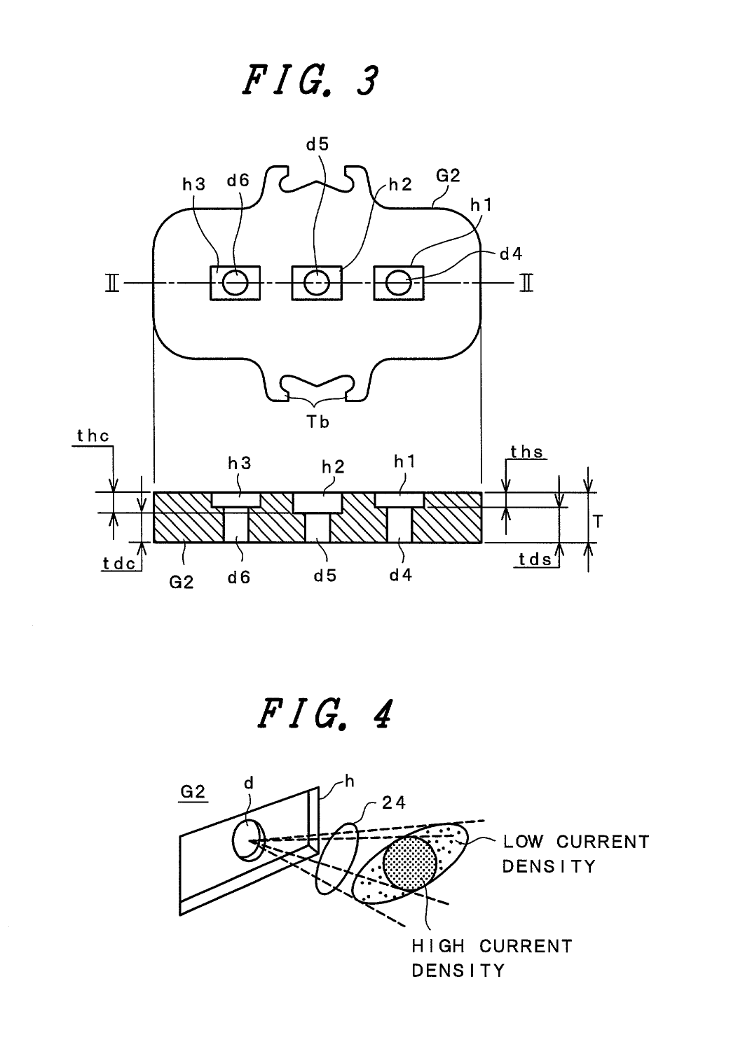

This is because that in addition to the correction of the lens magnification due to the rectangular recessed portions of the second electrode G2, the astigmatism which makes the spot shape of the electron beam on the phosphor screen longitudinally elongated is generated. This phenomenon is explained hereinafter in conjunction with FIG. 4 and other drawings which follows FIG. 4.

FIG. 4 is an explanatory view explaining the cross-sectional structure of the electron beam emitted from the rectangular recessed portion after passing the second electrode G2. The electron beam 24 which passes the electron beam aperture d made of a circular aperture of the second electrode G2 and is emitted from the laterally-elongated rectangular recessed portion h has a laterally-elongated cross-sectional shape in which the current density is high at the central portion and is decreased in the left and right direction (lateral direction).

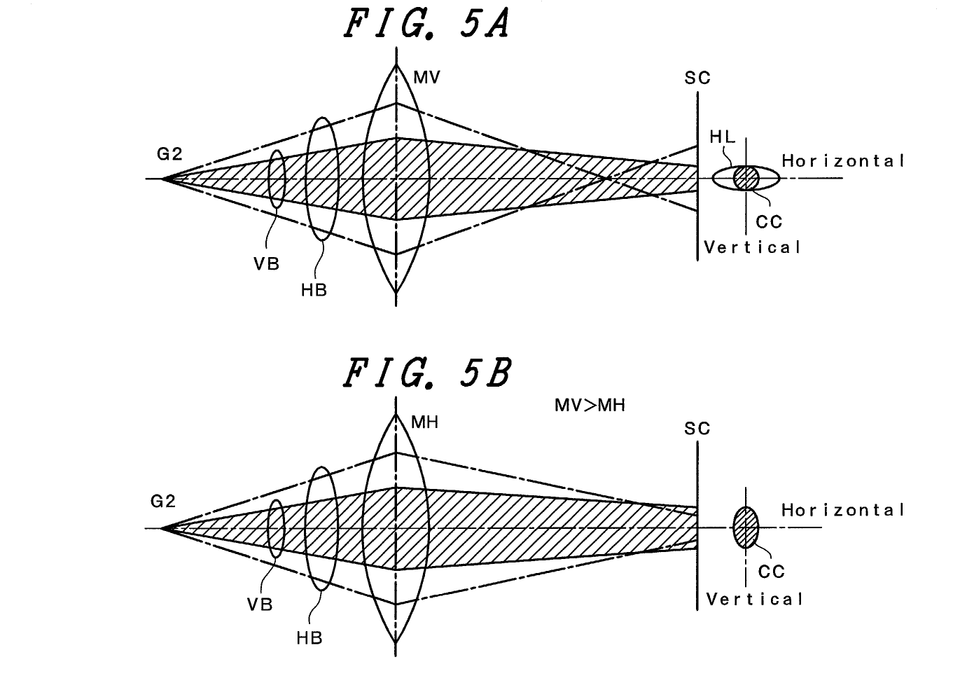

FIG. 5A and FIG. 5B are explanatory views for explaining the lens action of the electron lens which cancels a halo derived from the difference of the current density between the longitudinal direction and the lateral direction, wherein FIG. 5A is a view in which the vertical beam is optimally focused on the phosphor screen and FIG. 5B is a view in which the horizontal beam is optimally focused on the phosphor screen.

In FIG. 5A and FIG. 5B, HB indicates the electron beam in the lateral direction and VB indicates the electron beam in the longitudinal direction. The lens magnification at the time of optimum focusing in the vertical direction on the phosphor screen Sc is set to MV and the lens magnification at the time of optimum focusing in the horizontal direction on the phosphor screen Sc is set to MH.

Different from an optical system lens, in the electron lens, the influence of the spherical aberration is increased corresponding to the decrease of the incident angle of the electron beam and the electron beam is focused at a position in front of the phosphor screen SC. When taking the lens magnification in the vertical direction which exhibits the small beam diameter of the beam incident on the main lens as the reference, the beam diameter of the beam incident on the main lens is large in the horizontal direction. Accordingly, the electron beam in the horizontal direction receives the influence of the spherical aberration and hence, the electron beam is focused in front of the phosphor screen SC so that a laterally elongated beam shape is formed on the phosphor screen SC.

Here, the current density is high in the central portion and is low in the outside, wherein a portion having the high current density constitutes a core CC and a portion having the low current density constitutes a halo HC.

When the magnification of the main lens is lowered to cancel the halo in the horizontal direction, the focal length in the vertical direction becomes long and hence, the longitudinally elongated beam shape having astigmatism is formed on the phosphor screen.

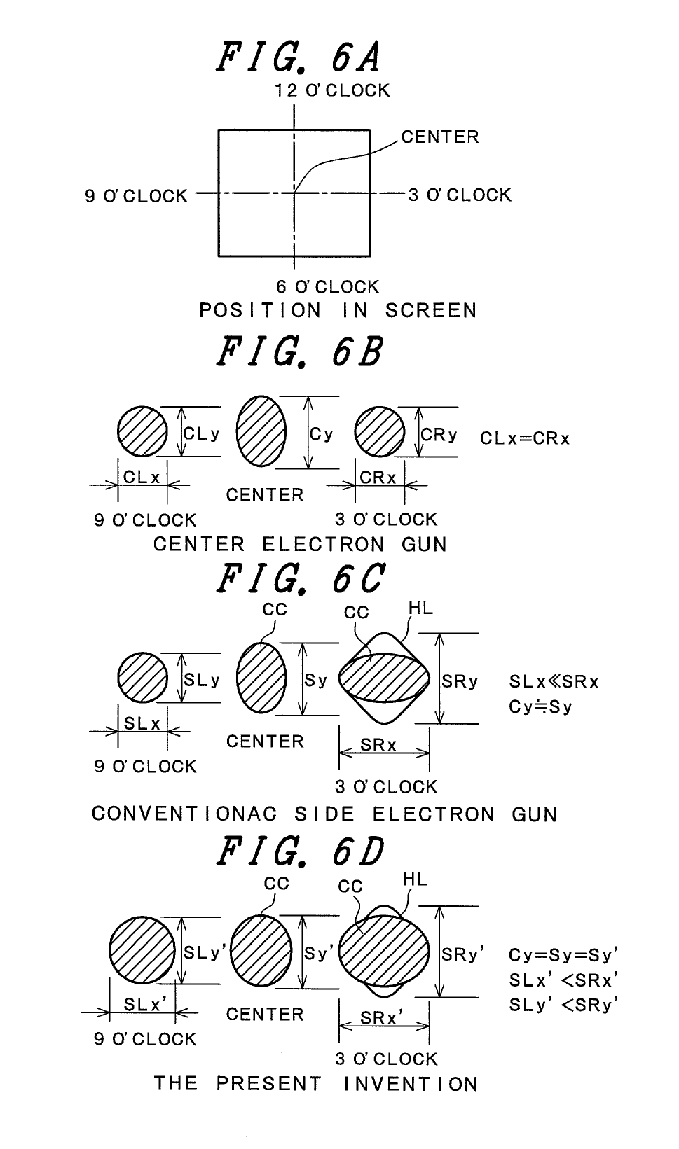

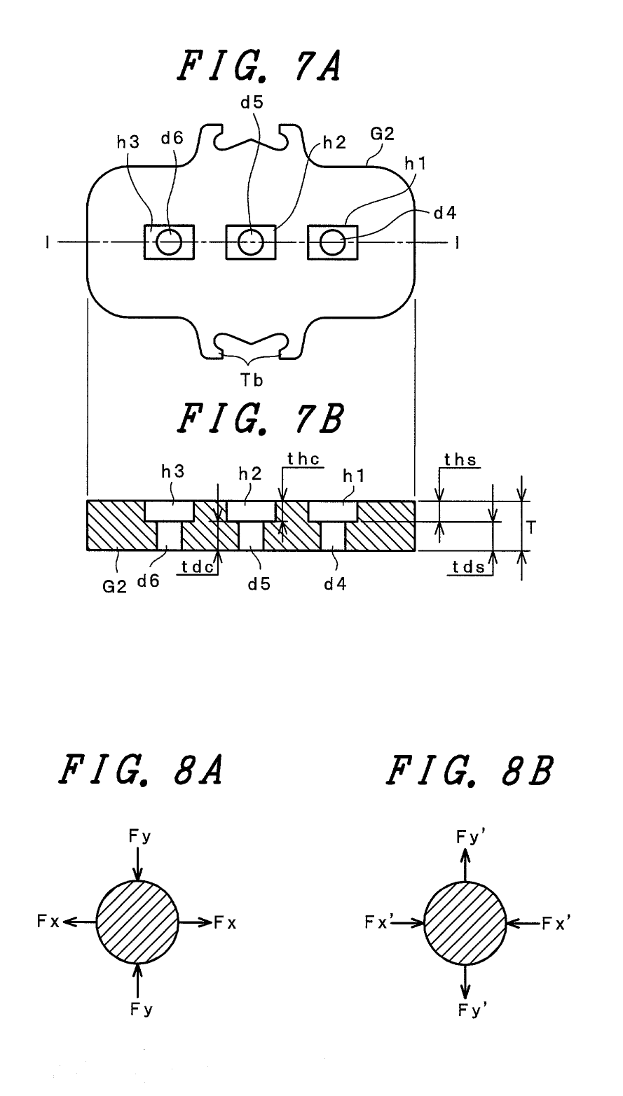

FIG. 6A, FIG. 6B, FIG. 6C and FIG. 6D are explanatory views for explaining the spot shape of the electron beam on the phosphor screen when the cathode ray tube is operated. FIG. 6A is the explanatory view for explaining positions (three o'clock, six o'clock, nine o'clock, twelve o'clock) on the screen. FIG. 6B is the view showing the spot shape of the center electron beam at nine o'clock, center and three o'clock, FIG. 6C is the view showing the spot beam shape of the side electron beam at nine o'clock, center and three o'clock in the prior art, and FIG. 6D is the view showing the spot beam shape of the side electron beam at nine o'clock, center and three o'clock according to the present invention.

At the center of the phosphor screen, by increasing the plate thickness tds of the side circular through aperture formed in the second grid electrode G2, the spot diameter of the side electron beam is increased compared to that of the center electron beam. However, since the depth of the side rectangular recessed portion is made small, the astigmatism derived from the rectangular recessed portion is decreased and hence, the diameter in the vertical direction of the side electron beam can be made equal to that of the center electron beam (Cy≅Sy).

In the periphery of the phosphor screen, corresponding to an increased amount of the through length (plate thickness) of the side electron beam apertures, the beam diameter in the deflection magnetic field can be made small so that the upper and lower halos derived from the deflection distortion and the laterally elongated flattening can be decreased.

In the prior art shown in FIG. 6C, the relationship between diameters SLx and SRx of the side electron beams was SLx<<SRx in the horizontal direction of the phosphor screen and the relationship between diameters SLy and SRy of the side electron beams was SLy<<SRy in the vertical direction of the phosphor screen. To the contrary, in the embodiment of the present invention shown in FIG. 6D, the relationship between diameters SLx′ and SRx′ of the side electron beams was SLx′<SRx′ in the horizontal direction of the phosphor screen and the relationship between diameters SLy′ and SRy′ of the side electron beams was SLy′<SRy′ in the vertical direction of the phosphor screen. In this manner, the beam spot diameter difference between the left and the right in the periphery of the phosphor screen can be made small.

According to this embodiment, the color cathode ray tube which can realize the optimum focusing over the entire region of the phosphor screen by reducing the non-uniformity of the beam spot shape derived from the deflection quantity can be obtained.

According to the present invention, it becomes possible to provide the color cathode ray tube which can realize the optimum focusing over the entire region of the phosphor screen by reducing the non-uniformity of the beam spot shape depending on the deflection quantity.

What is claim is:

1. A color cathode ray tube including a vacuum envelope which is comprised of a panel having a phosphor screen formed on an inner surface thereof, a neck accommodating an electron gun which emits one center electron beam and two side electron beams in an in-line array and a funnel which connects the panel and the neck, wherein
the electron gun includes a cathode portion which arranges one center cathode and two side cathodes in an in-line array, a first electrode, a second electrode, a third electrode and an anode electrode,
the second electrode includes three electron beam apertures made of one center electron beam aperture and two side electron beam apertures, each one of three electron beam apertures includes a through aperture having a circular shape and a recessed portion having a rectangular shape, three through apertures are respectively arranged at center portions of three recessed portions, and
the depth of the recessed portion of the center electron beam aperture is set larger than the depth of the recessed portions of side electron beam aperture.

2. A color cathode ray tube according to claim 1, wherein the recessed portions have long sides thereof in the in-line direction.

3. A color cathode ray tube according to claim 1, wherein the through length of side electron beam apertures is set larger than the through length of the center electron beam aperture.

4. A color cathode ray tube according to claim 1, wherein the total of the through length and the depth of the rectangular recessed portion is set equal at the center electron beam aperture and at the side electron beam apertures.
